(19) United States
(12) Patent Application Publication
(10) Pub. No.: US 2024/0026867 A1
(43) Pub. Date: Jan. 25, 2024

(54) SERVO ARRANGEMENT

(71) Applicant: Danfoss Power Solutions GmbH & Co. OHG, Neumünster (DE)

(72) Inventors: Carsten FIEBING, Jevenstedt (DE); Heiko LAFFRENZEN, Ostenfeld (DE); Thoms REINHARDT, Holzbunge (DE)

(21) Appl. No.: 18/249,146

(22) PCT Filed: Dec. 15, 2021
(86) PCT No.: PCT/EP2021/085999

§ 371 Date: Apr. 14, 2023

(30) Foreign Application Priority Data
Jan. 22, 2021 (CN) 202110089627.9
Jan. 22, 2021 (CN) 202120189010.X

(51) Int. Cl. F04B 1/324; F15B 15/14

(52) U.S. Cl. CPC F04B 1/324; F15B 15/1447; F15B 15/1476; F15B 15/1428; F04B 2203/09

(57) ABSTRACT

A variable displacement hydraulic unit with a housing in which a rotating group is housed, wherein the displacement volume of the rotating group is variably adjustable by means of a swivel element able to tilt around a tilt axis perpendicular to the rotational axis of the rotating group. The swivel element can be actuated by at least one servo unit including a servo cylinder integrated in the housing and a servo piston moveably within the servo cylinder. The head of the servo piston can be pressurized in the servo cylinder such that a movement of the servo piston coupled to the swivel element via a servo piston shaft tilts the swivel element; wherein the servo unit is located within the housing on that side of the swivel element on which no rotating group is located, and follow a working direction substantially parallel to the rotational axis of the rotating group.

### CROSS-REFERENCE TO RELATED APPLICATIONS

This application is a National Stage application of International Patent Application No. PCT/EP2021/085999, filed on Dec. 15, 2021, which claims priority to Chinese Patent Applications No. 202110089627.9, filed on Jan. 22, 2021, and No. 202120189010.X, filed on Jan. 22, 2021, each of which is hereby incorporated by reference in its entirety.

### TECHNICAL FIELD

The field of the invention relates to variable displacement hydraulic axial piston units having a swivel element for adjusting the displacement volume of a rotating group of the hydraulic unit. Furthermore, the field of invention is related to variable displacement hydraulic single units or variable displacement hydraulic tandem units as well as to hydrostatic transmissions equipped with such hydraulic units. In case of hydraulic tandem units and hydrostatic transmissions according to the invention more than one rotating group is arranged within one common housing. At least one of these rotational units is adjustable in its displacement volume according to the invention. Also covered by the invention are hydrostatic transmissions comprising a variable displacement hydraulic axial piston unit combined with one or more radial piston units.

### BACKGROUND

In general, hydraulic units and hydraulic transmissions are used in propel applications for transmitting mechanical energy from a drive engine to a consumer, which is propelled by hydraulic or mechanical energy. Frequently, compact hydraulic units are used as available space is usually restricted by vehicle manufactures. For example, such hydraulic units, or transmissions, could be incorporated in tractors where they are mounted onto or into mechanical gear boxes. Here they must fit into a certain frame of the tractor, for example, into the leg room of the driver.

In order to minimize the construction space for a hydraulic unit or hydrostatic transmission, direct displacement control is the preferable method of adjusting the displacement volume of the rotating group. Specifically, a mechanical systems of levers and/or rods are used to transmit the operators command for a required displacement volume to the corresponding rotating group. In some applications the swivel motion of a swivel element is done externally by a bolt-on servo unit, however this specific servo unit consumes valuable construction space.

### SUMMARY

Hence, there is a need in the state of the art to provide a swivel element tilt system capable of variably adjusting the displacement volumes of at least one rotating group of a hydrostatic axial piston unit, or a hydraulic transmission comprising such a rotating group. Herein, the given shape of available space of an apparatus equipped by such a hydraulic unit should not be extended, the inventive displacement adjusting system should be based on a hydraulic servo system. Furthermore, the inventive displacement adjusting system should be controllable by means of a manual displacement control (MDC), a hydraulic displacement control (HDC), and/or an electronic displacement control (EDC). Moreover, the proposed displacement adjusting system shall allow a high variability and simple conversion for allowing mechanical position feedback with optional electrical position feedback, or with mechanical position feedback, and/or optional with electrical position feedback, wherein load dependent and/or load independent displacement controls can be used.

The technical problem of the invention is solved by a variable displacement hydraulic axial piston unit according to claim 1, wherein preferred embodiments are described in the subclaims directly or indirectly depending on claim 1.

In order to solve the technical problem of the invention, a variable displacement hydraulic axial piston unit according to the invention is equipped with a housing in which at least one rotating group is housed. The displacement volume of at least one rotating group can be variably adjusted by means of a swivel element which is capable of being tilted around a tilt axis, and oriented perpendicular to the rotational axis of the rotating group. According to the invention the swivel element, which is also called the swashplate can be actuated by at least one servo unit comprising a servo cylinder accommodated in the housing. A servo piston arranged within the servo cylinder can be pressurized at its servo piston head within the servo cylinder so that a movement of the servo piston, which is coupled to the swivel element via a servo piston shaft, tilts the swivel element. According to the invention, the above described servo unit is located within the housing of the hydraulic axial piston unit or the hydrostatic transmission. Further, the servo unit is arranged at the opposite side of the swivel element to where the cylinder block is located. In order to be capable to tilt the swivel element around the swivel element tilt axis the servo unit, according to the invention, follows a working direction substantially parallel to the rotational axis of the rotating group, wherein the force application point, respectively the fixation point of the servo piston shaft on the swivel element, is laterally spaced from the swivel element tilt axis in order to facilitate a tilt moment around the tilt axis.

Deviating from the state of the art, the servo unit according to the invention is arranged on that side of the swivel element (swashplate) on which the cylinder block is not located. Servo units according to the state of the art are respectively arranged on the same side of the swivel element as the displacement pistons or the cylinder block. For internal servo units, the housing of the hydraulic unit must be designed in a way that the servo unit is also housed within. According to the state of the art, the servo cylinder as well as the servo piston are arranged in parallel to the rotating group, resulting in the housing being radially bigger than a comparative housing which has to cover the rotating group alone.

The invention proposes to arrange the servo unit on the other side of the swashplate wherein a servo cylinder can be part of the housing. Herein the servo cylinder can be a separate part or, in a preferred embodiment integrally formed together with and within the hydrostatic unit housing.

According to the invention, a servo piston is arranged within the servo cylinder such that the servo piston head can be pressurized by a servo pressure, and such that its servo piston shaft protrudes substantially in parallel to the rotational axis of the rotating group towards the swivel element. The attachment point of the servo piston shaft is thereby moved beside the swivel element tilt axis in order that a force generated by the servo unit in linear direction onto the swivel element generates a moment around the swivel element tilt axis. Hence, when the servo piston is pushed out of the servo cylinder the servo piston shaft transmits a linear force parallel to the rotational axis of the rotating group, thereby causing a tilting movement of the swivel element.

Preferably, the servo piston shaft is attached to the swivel element in an articulated manner, as with tilting/rotating the swivel element around the swivel element tilt axis the lateral distance of the servo piston attachment point to the swivel element tilt axis decreases, when seen in direction of the rotational axis of the rotating group. Further, preferably, in order to compensate this lateral movement of the servo shaft attachment point the servo piston skirt is designed in a convex shape, e.g. spherically. Seals which can be arranged on the servo piston skirt are preferably elastic seals designed in order that a sealing contact to the inner walls of the servo cylinder is maintained during servo piston curve-linear movement.

According to the invention, the servo piston shaft is attached to the swivel element, e.g., with a kind of ball joint, hinge joint, pin joint or similar, preferably comprising a calotte on the swivel element into which a convex end of the servo piston shaft can be inserted or placed-in, such that linear forces in direction parallel to the rotational axis of the rotating group can be transmitted to the swivel element without producing lateral forces on the servo cylinder lateral surface.

In an embodiment of the invention, it is imaginable that the servo cylinder is attached to the housing in such a manner that the servo cylinder is capable of pivoting around a pivot point, or an axis parallel to the swivel element tilt axis, in order to compensate the lateral movements of the servo piston shaft attachment point on the swivel element. These pivoting movements of the servo piston do not need to be big, and only small inclinations of the servo unit longitudinal axis (servo cylinder axis) have to be compensated.

In another embodiment of the invention, the fixation of the servo piston shaft on the swivel element is designed in a way that the servo piston shaft end can slide on the swivel element, in order that the servo cylinder and the servo piston longitudinal axis can be maintained parallel to the rotational axis of the rotating group, when the swivel element is tilted around its tilt axis. This can be achieved, for example, by means of a sliding engagement on the swivel element to which the servo piston shaft is attached, or, for example by means of a slit perpendicular to the swivel element tilt axis in which the servo piston shaft end is received in a manner that allows a linear degree of displacement. In one simple embodiment, the free end of the servo piston shaft can be shaped convex such that a lateral movement relative to the swivel element can be compensated by a kind of rolling movement on the swivel element, wherein the servo piston tilts due to the convex shape of the servo piston skirt.

According to the invention, the servo unit can be used for rotating groups having a swivel element for adjusting the displacement volume from a zero position to a maximum position in one direction, or vice versa from a maximum position towards a zero position, or also for rotating groups having a displacement element which can be tilted from one maximum position on one side to another maximum position on the other side. Whereby, the high-pressure side can be interchanged with the low-pressure side, when the rotational direction is maintained. In either case, end stops for a tilting movement can be provided either by the servo piston head abutting against the servo cylinder bottom, or by providing an end stop on the sliding surface side of the swivel element at an end stop stationary to the housing. In case the rotating group is equipped with a swivel element which can be tilted in both directions with respect to a neutral position, it is preferred that the servo piston is located in this neutral position, halfway of its possible stroke in the servo cylinder of the servo unit, i.e., on half-stoke.

For embodiments having a swivel element capable of being tilted in both directions, it is preferred to arrange two servo units according to the invention on either side of the swivel element tilt axis, i.e. a pair of servo units. By means of such a pairwise arrangement a neutral position of the swivel element, in which the rotating group does not show a displacement volume, the two servo units are at equal pressure in order to define and hold this neutral position in which possible moments created by these two servo units are compensated by each other. In such embodiments, it is further preferred that more than one pair of servo units are arranged on that side of the swivel element facing away from the cylinder block. For instance, another pair of servo units is arranged in parallel, such that the four servo units are distributed on the swivel element forming a kind of a cuboid around the drive axis. In other words, the working directions of the servo units are arranged in four different quadrants when looking on the swashplate in direction of the rotational axis of the rotating group. Here, the quadrants are formed by the swivel element tilt axis intersected by a plane perpendicular to the swivel element tilt axis and contain the whole rotational axis of the rotating group. This special arrangement provides for an equilibrium of forces acting on the swashplate, as four force application points on the swashplate side opposite to the cylinder block prevent the swashplate from being inclined with respect to a plane parallel to the swashplate tilt axis, and perpendicular to the rotational axis of the rotating group.

A person skilled in the relevant art derives from the above that, when an arrangement symmetrical with respect to the tilting axis of the swivel element is not feasible, it is possible to compensate lateral deviations from the symmetry by adapting the diameter of the servo cylinders and the servo pistons, respectively, in order to compensate the moments which can be created by each servo unit.

In another embodiment of the invention in which the swivel element can be tilted in both directions around the swivel element tilt axis, it is preferred that when one servo piston on one side with regard to the swivel element tilt axis is pushed outwards of the servo cylinder, the other servo piston located on the other side of the swivel element tilt axis is pressed into the servo cylinder due to the tilting movement of the swivel element. An analogous view is valid if two or more pairs of servo units, according to the invention, are arranged symmetrically with regard to the swivel element tilt axis on the swivel element side opposite the cylinder block.

Irrespective of how many servo units are applied in order to displace/tilt the swivel element, a servo pressure for pressurizing at least one servo piston in a servo cylinder is provided by an internal or an external pressure source. For this, the internal or external pressure source can be controlled by a control unit in a manner known in the art. This means that the servo pressure level supplied to the servo cylinders can be controlled hydraulically, mechanically, electromechanically, electronically or in any other way known to a person with skills in the relevant art. For this, in a special embodiment, a servo pump may be bolt-on on the outer side of the housing of the hydraulic unit according to the invention. However, a skilled person also contemplates the possibility to use the system pressure, and pressure reducing valves, in order to control the level of servo pressure provided to the servo cylinders. This internal system pressure may be provided, for example, by a charge pump of a closed-circuit hydraulic system.

Irrespectively of what kind of pressure source is used the servo system for adjusting the displacement volume, according to the invention, also allows for load dependent servo pressure controls as the servo unit/servo units, according to the invention, can be provided with servo pressure by small working fluid lines, as the amount of servo fluid (hydraulic fluid or even air) for moving the servo pistons in the servo cylinders is relatively small. These servo fluid lines can be installed, and adapted, in a simple manner and varied as needed. Here, the use of flexible tubes or hoses is indicated, and such a tube or hose is well-known to a skilled person.

As described above, the swivel element can be tilted around its swivel element tilt axis by means of a servo unit arranged on the opposite side on the swivel element, then a sliding surface, on which working pistons in a cylinder block of the rotating group abut. In case, the swivel element is tilted from its initial position, it can be brought back to its initial position by another servo unit arranged, for instance, symmetrically with regard to the swivel element tilt axis on the same swivel element side. In another embodiment, according to the invention, this can be done also by means of servo springs, which are compressed when the swivel element is tilted/displaced from the initial position.

If the swivel element can be tilted only in one direction, the restoring of the swivel element into its initial position can be done by means of a servo spring arranged on the same swivel element side symmetrically to the swivel element tilt axis. Thereby, the maximum angle of tilt can be defined by a maximum compression of the servo spring or by an end stop formed, for instance, at the housing. However, such an embodiment may be feasible only if the wrap angle of the cradle bearing of the swivel element is greater than 180°.

In case the swivel element is capable of tilting in either direction, it is preferred according to the invention to locate several springs on the same swivel element side on which the cylinder block is arranged. By doing this, an expansion of the servo unit causes a compression of a servo spring, located opposite to the servo unit, more or less in prolongation of the servo unit longitudinal axis.

When the swivel element of a rotating group is equipped with servo units according to the invention, it is preferred to arrange for each servo unit a corresponding servo spring arrangement on the other side of the swivel element. In this case, when pairs of servo springs are located on the swivel element sliding surface side, at least one spring is arranged at either side of the swivel element tilt axis. It is preferred that the servo springs are pre-tensioned, when the swivel element is in its neutral position. By doing this, two, four or more servo springs are capable of holding the swivel element in a neutral position as the spring forces create tilting moments on the swivel element of equal height, however, in different directions, so that the moments compensate each other. According to the invention, such an arrangement of pairs of servo spring arrangements, which are preferably arranged symmetrically with regard to the swivel element tilt axis, is called a restoring means, as it is capable of restoring the swivel elements neutral position as described before. A skilled person detects that, when a symmetrical arrangement of servo springs is not possible, a compensation of spring forces, as commonly known, is needed.

In order for the servo springs to act on the swivel element, a support, preferably stationary with the housing, for the servo springs has to be provided. Such a support surface or similar can be formed on the housing or provided on a so-called end cap of the hydrostatic unit, for example. In general, the servo springs are orientated with its longitudinal axis parallel to the rotational axis of the rotating group and are attached on the swivel element in an articulated manner analogous to the servo piston shaft, however, on the other side of the swivel element. For this, spring seats are used, preferably. By using spring seats and spring guiding means, the servo spring can be mounted pre-tensioned. Within the disclosure of the present invention, an assembly group comprising a servo spring, at least one spring seat and spring guiding means is called servo spring arrangement. Preferably, a servo spring arrangement also comprises attachment means for attaching the servo spring arrangement to the swivel element.

As the servo springs are supported with its ends remote to the swivel element preferably on a supporting element at a supporting surface stationary with the housing, they can also provide for an end stop for the tilt angle of the swivel element. This can be done, for instance, by means of an outer tube or inner rod, adequately adapted in its length and serving in parallel as guiding means. However, this end stop can be provided by the minimum spring length, as well, i.e. at maximum compressed state.

As mentioned before, the servo springs can be guided within external tubes or with internal rods for possibly providing an end stop for the angle of tilt of the swivel element. These tubes or rods may also be adapted for providing one or two spring seats for the servo springs. Preferably, one of these servo spring seats is designed so that the pre-tensioned force of the servo spring in the neutral position of the swivel element can be adjusted, for instance, by means of screwing in or out the spring seat with respect to the guiding means. When using such adjustable spring seats, benefits at time of assembly of the hydrostatic unit or transmission can be achieved, as well.

In another aspect of the invention, in particular for two-directional tiltable swashplates with one or more pairs of servo springs arranged at the swashplate sliding surface side, the servo spring arrangement can be used to hold the swashplate in its cradle bearing when the swashplate is tilted around the tilt axis. As the servo units according to the invention are located on the opposite side on the swashplate facing away from the cylinder block, the servo units, when tilting the swashplate, are pushing the swashplate away from its cradle bearing. To compensate this, servo spring arrangements according to the invention are used, as they can also provide a swashplate down-hold force contrary to the servo piston tilt force in order to hold down the swashplate in its cradle bearing.

### BRIEF DESCRIPTION OF THE DRAWINGS

In the following Figures, exemplary embodiments for the servo unit, for the servo springs, for the servo spring arrangements, and for combinations thereof according to the invention, as described before, are presented. In the embodiments shown in the following Figures, different possibilities of arrangement are shown, which can be combined with each other without leaving the spirit of the inventive concept, wherein combinations not described are covered by the invention as well. Further, the presented embodiments do not limit the scope of the invention. The following Figures show:

FIG. 1 is a schematic view of a first embodiment according to the invention;

FIG. 2 is a schematic view of a second embodiment according to the invention;

FIG. 3 is a sectional view of a third embodiment according to the invention;

FIG. 4 is a sectional view of a fourth embodiment according to the invention;

FIG. 5 is a detailed view of a fifth embodiment according to the invention;

FIG. 6 is a schematic view of the fifth embodiment according to the invention; and

FIG. 7 is a rear view of the embodiment according to FIG. 4.

### DETAILED DESCRIPTION

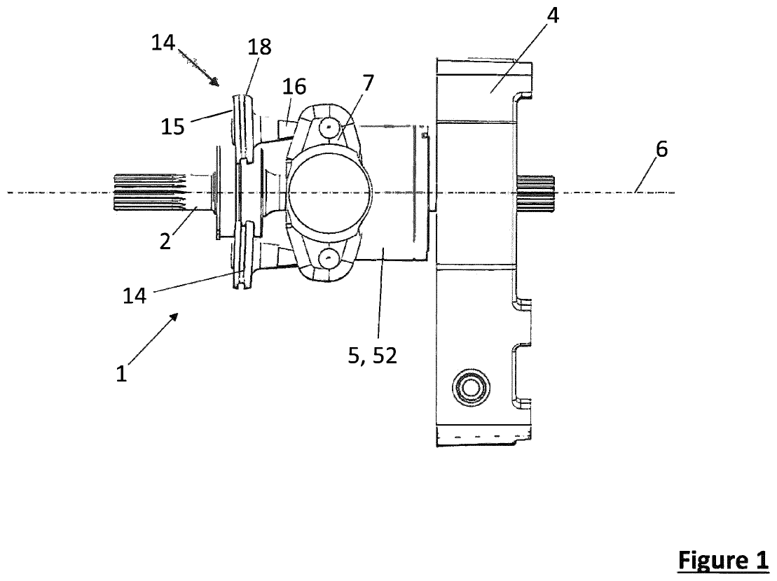

FIG. 1 is a schematic view of a first embodiment of the invention, showing an end cap 4 in which a drive shaft 2 of a rotational group 5 is mounted. Rotational group 5 is rotational with regard to a rotational axis 6. The displacement volume of rotational group 5 is adjustable by means of a swivel element 7 which is shown in a neutral position in which displacement pistons of the rotational group 5 do not show any stroke. Swivel element 7 can be tilted by means of servo piston 14 in either direction clockwise or counterclockwise. Servo pistons 14 show a servo piston head 15 which can be pressurized in a servo cylinder (not shown) so that servo piston 14, guided by a servo skirt 18, transmits a linear force along servo shaft 16 towards the swivel element 7 in order to tilt/rotate swivel element 7, thereby setting the displacement volume of rotational group 5. When the swivel element 7 is tilted by means of one of the servo pistons 14, the active servo piston 14 is moving towards the right and the non-active servo piston which is not pressurized is moving to the left. As can be derived from FIG. 1, the hydraulic unit 1 according to FIG. 1 is in its neutral position, i.e. the rotating group 5 does not show any displacement volume, hence equal pressure acts on both servo pistons 14.

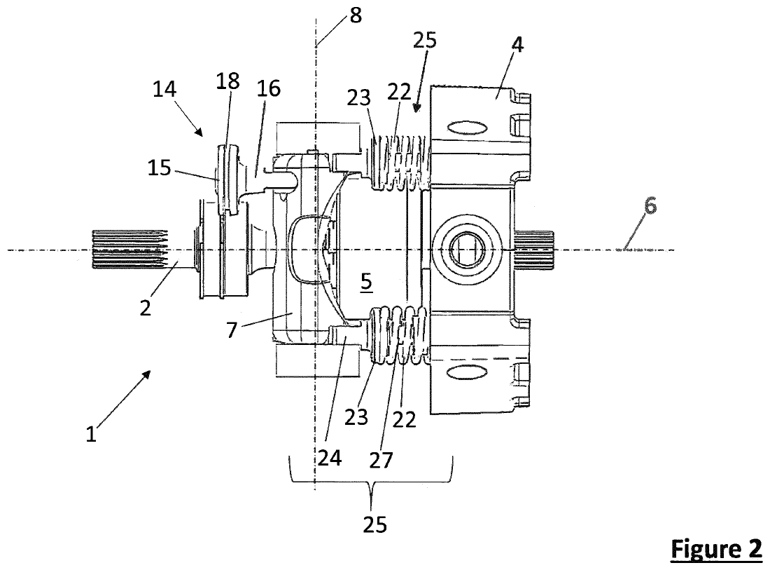

In the schematic view of FIG. 2—a side view of another embodiment according to the invention —, only one servo piston 14 is arranged in order to move the swivel element 7 around its tilt axis 8 in either direction. If the swivel element 7 is tilted around the swivel element tilt axis 8, one of the two servo spring arrangements 25 shown in FIG. 2 is compressed, thereby generating a counterforce to the pressure force acting on servo piston 14, respectively on servo piston head 15. The servo pressure force is proportional to the servo spring force in this arrangement, such that intermediate positions between a maximum angle and a minimum angle can be obtained by adjusting/setting the servo pressure. As well as in FIG. 1, the servo piston 14 in the embodiment of FIG. 2 is arranged at the side of the swivel element opposite to the cylinder block 52 of the rotating group 5. This provides for a very compact design of the whole hydraulic unit 1. A person skilled in the art derives from FIG. 1 as well as from FIG. 2 that the end cap 4 constitutes part of the hydraulic units housing 3 involving the components shown in FIGS. 1 and 2.

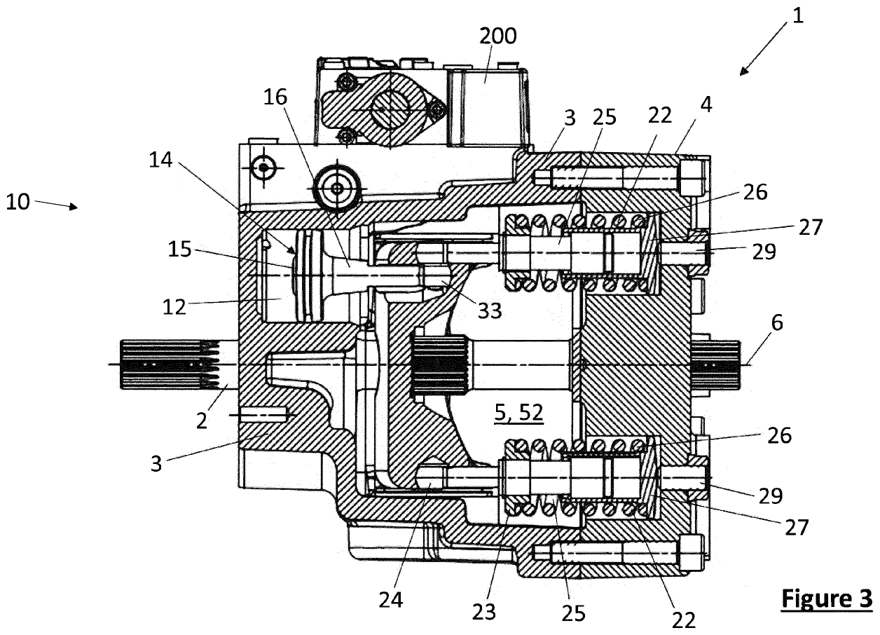

An exemplary embodiment showing a sectional cut of a hydraulic unit 1 according to the invention is shown with FIG. 3. It can be seen that the hydraulic unit according to the invention shows a very compact design. The displacement volume of the hydraulic unit 1 can be adjusted by means of a servo unit 10, which is arranged integrally with the housing 3 of the hydraulic unit 1. As shown with FIG. 3, the servo units 10, comprising a servo cylinder 12 and a servo piston 14, are arranged on the opposite side of the swivel element 7 than a cylinder block 52 of a rotating group 5 whose displacement volume can be adjusted by means of the swivel element 7. In FIG. 3, two servo spring arrangements 25 are shown which are able to counteract to the servo unit 10. Thereby, the servo spring arrangements 25 are connected to the swivel element 7 in an articulated manner, as will be shown in more detail further on. The same is valid for servo piston shaft 16, as the fixing point 33 on the swivel element 7 performs a circular motion when the swivel element 7 tilts around the swivel element tils axis 8.

In FIG. 3, it is also shown that the servo springs 22 are guided by an internal guiding means 27 which also provides a seat 26 for servo spring 22. Seat 26 can be moved parallel to the rotational axis 6 of the hydraulic unit 1 in order to adjust the servo spring forces. On the other end of servo springs 22, a spring seat 23 is fixed at a first end 24 of servo spring arrangement 25 in order to pre-tension servo spring 22. Together with the spring seat 26 on the second end of servo spring 22, an embodiment for a servo spring arrangement 25 is shown in which the servo spring arrangements 25 can be mounted as an assembly group into the hydraulic unit 1. The pre-tensioning forces of the servo springs 22 can be used to define the neutral position of hydraulic unit 1 in case the servo unit 10 is non-pressurized.

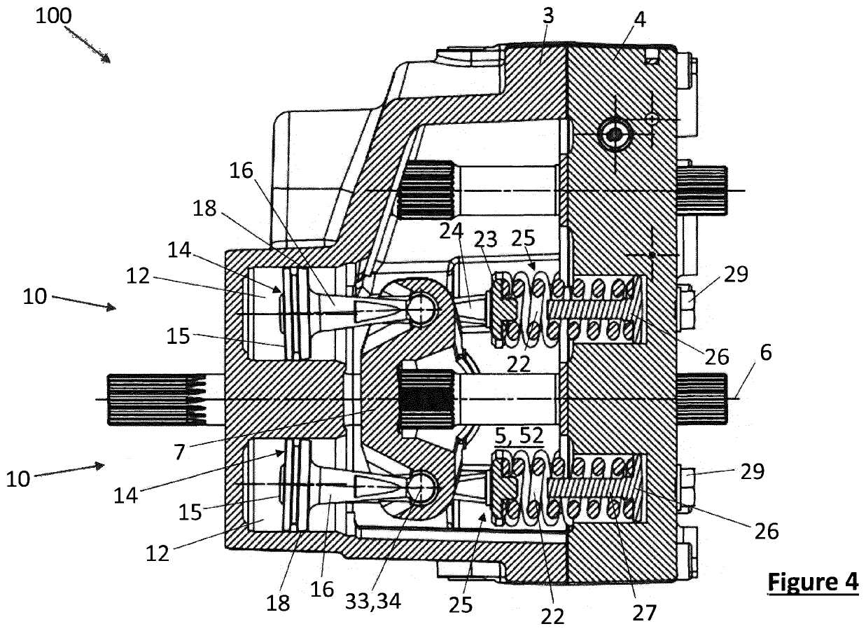

In FIG. 4, another embodiment according to the invention is shown in a sectional view, showing a compact hydrostatic transmission 100 comprising a hydrostatic unit 1 which is adjustable in its displacement volume by means of tilting a swivel element 7. For this, two servo units 10 are arranged on either side of rotational axis 6. Each servo unit 10 comprising a servo piston 14, whose servo piston head 15 can be pressurized by a servo pressure in a servo cylinder 12. When the servo piston-head 15 in the servo cylinder 12 is pressurized, the servo piston 14 moves guided by its servo skirt 18 along the servo cylinder walls towards the swivel element 7, thereby tilting the swivel element 7. When the swivel element 7 is tilted, the fixation points 33 of the servo piston shafts 16 to the swivel element 7 perform a rotational motion. In order to compensate this rotational movement of fixations points 33, the servo piston skirts 18 show a convex shape, so that the servo piston shaft 16 in neutral position of the swivel element 7 is parallel to rotational axis 6 of the rotational group 5 and can pivot around a small angle in order to not impede the rotational motion of the swivel element 7. A person with skills in the relevant art detects from FIG. 4 that, when the swivel element 7 is tilted out of its neutral position, the inclination angle of both servo piston shafts 16 can be changed with respect to a zero position of the swivel element 7 due to the convex shape of the servo piston skirt 18. The servo piston skirts 18 are also capable of providing a sealing with the servo cylinder 12 in such an inclined orientation.

On the opposite side of swivel element 7 in the embodiment of FIG. 4, two servo spring arrangements 25 can counteract the servo pressure in one of the two servo units 10. Thereby, the first ends 24 of the servo spring arrangements 25 are also fixed to the swivel element 7 in an articulated manner, such that a basically longitudinal axis of the servo spring arrangements 25 can follow the rotational movement of fixation points 34 on swivel element 7 (in FIG. 4 below fixing points 33 of the servo piston shafts 16). If one of the two servo units 10 in FIG. 4 is pressurized with a servo pressure, the corresponding servo spring arrangement 25 on the other side of swivel element 7 is compressed, thereby providing a counterforce to the servo force in servo cylinder 12. The other servo spring arrangement 25 is elongated or decompressed, respectively.

As shown with FIG. 3, the arrangement of FIG. 4 also comprises servo spring force adjustment means 29 with which the pre-tension of the servo spring arrangements 25, i.e. the servo springs 22, can be set and adjusted such that the per-tensioning forces in a neutral position of the swivel element 7 of both servo spring arrangements 25 are equal and capable of positioning the swivel element 7 in the neutral position. Thus, the servo spring arrangements 25 form restoring means 20 for the neutral position of the swivel element 7.

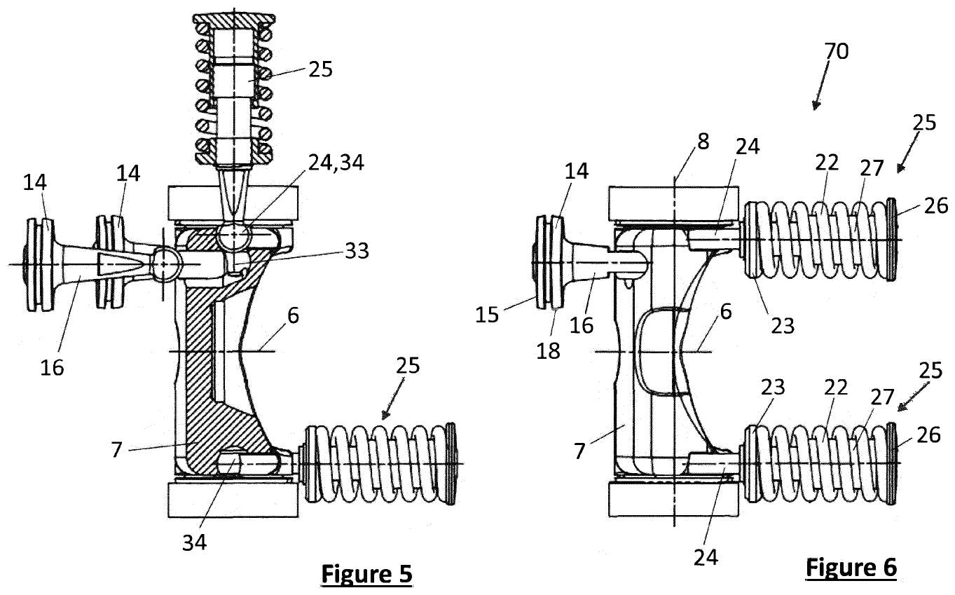

With FIGS. 5 and 6, a detailed view of an inventive servo arrangement according to the invention is shown, wherein a method for assembling servo pistons 14 and servo spring arrangements 25 to the swivel element 7 are shown. Especially for the fixing point 33 of servo shaft 16 to the swivel element 7, it can be seen that the end of servo shaft 16 is designed in an exemplary spherical form, so that the servo shaft 16 can be mounted in a calotte formed in the swivel element 7. The servo piston 14 is then fixed to swivel element 7 by moving the servo piston 14 in a direction parallel to the rotational axis 6 towards its fixing point 33, for example. Subsequently, the servo piston 14 can be rotated around an axis parallel to the swivel element tilt axis 8 by, e.g., 90° for fixing the servo piston 14 in its end position. The second servo piston 14 in FIG. 3 is shown is such a fixed position, for instance, wherein the second servo piston 14 is located in the drawing plane behind the non-assembled servo piston 14 in the foreground.

In an analogous way, servo spring arrangement 25 can be fixed to the swivel element 7 in a kind of bayonet lock. Here, servo spring arrangement 25 is inserted into the swivel element 7 parallel to swivel element tilt axis 8 with its ball-like first end 24, then pivoted from the vertical orientation into a horizontal position parallel to the rotational axis 6, and similar to the position of the second servo spring arrangement 25. In another embodiment, the servo spring arrangement 25 is rotated around its longitudinal axis before pivoting into the horizontal position in order to engage with swivel element 7, for example. Here, a person skilled in the art knows several forms of connecting two parts by a bayonet like lock. However, bayonet locks for fixation of servo pistons 14 as well as of servo spring arrangements 25 on a swivel element 7 are new over the state of the art.

In FIG. 6, a swivel element servo unit assembly group 70 is shown ready for being mounted into an axial position unit housing 3, for example, into the servo unit shown with FIG. 4. The rotating group 5 with drive shaft 6 could be mounted between the servo spring arrangements 25 in a following assembly step of the hydraulic unit.

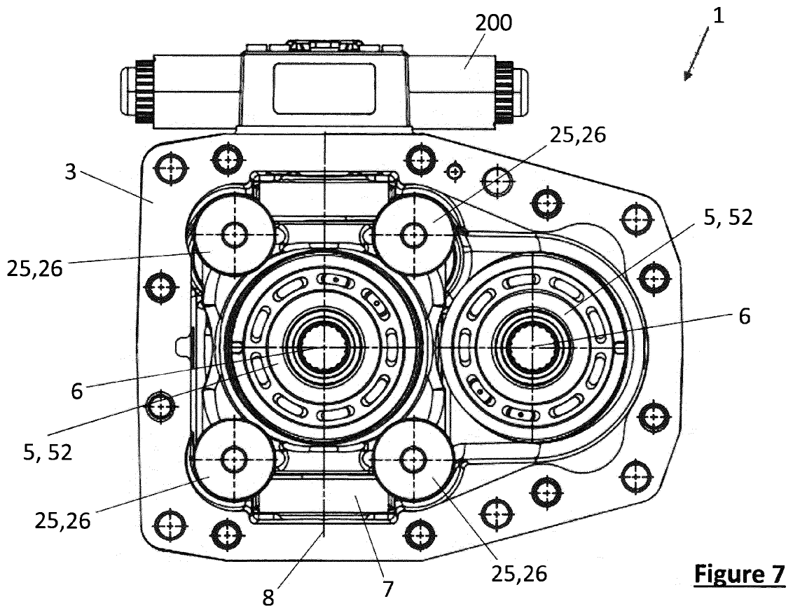

FIG. 7 shows an example for a hydrostatic transmission in which two rotating groups 5 are arranged in parallel, wherein only the left one of FIG. 7 is adjustable in its displacement volume. For this, the servo units 10 according to the invention which are hidden by the rotating group 5 and the swivel element 7 are mounted as well as four servo spring arrangements 25 at four locations. These four locations can be seen as two pairs of symmetrical locations. The servo units 10 and the servo spring arrangements 25 of each pair are arranged on either side of the swivel element tilt axis 8 and on either side of rotational axis 6, which is in the center of rotational group 5. Such a four-quadrant arrangement is preferred in order to symmetrically hold the swivel element in its neutral position in case that servo pressure is absent. On the other hand, such a four-point support for the swivel element 7 prevents from non-desired pivot motions of the swivel element 7 and, in the worst case, of pivoting or vibrating of the rotating group 5, as the swivel element 7 is laterally as well as vertically, or horizontally, supported by at least two servo spring arrangements 25—in case the swivel element 7 is tilted to maximum tilt position by means of a servo pressure acting in the servo unit 10.

From the above disclosure and the accompanying Figures and claims, it will be appreciated that the hydraulic unit 1 according to the invention offers many possibilities and advantages over the prior art. It will be appreciated further by a person skilled in the relevant art that further modifications and changes could be made to the hydraulic unit according to the invention without parting from the spirit and scope of this invention. Hence, such modifications and changes are within the scope of the claims and covered by them. It should be further understood that the examples and embodiments described above are for illustrative purposes only and that various modifications, changes or combinations of embodiments in the light of thereof, which will be suggested to a person skilled in the relevant art, are included in the spirit and purview of this application.

What is claimed is:

1. A variable displacement hydraulic unit with a housing in which a rotating group is housed, wherein the displacement volume of the rotating group is variably adjustable by means of a swivel element tiltable around a tilt axis perpendicular to the rotational axis of the rotating group, which swivel element can be actuated by at least one servo unit comprising:
a servo cylinder integrated in the housing;
a servo piston moveably within the servo cylinder, wherein the head of the servo piston can be pressurized in the servo cylinder, such that a movement of the servo piston, which is coupled to the swivel element via a servo piston shaft, tilts the swivel element;
wherein the servo unit is arranged within the housing on that side of the swivel element on which no rotating group is located, and follows a working direction substantially parallel to the rotational axis of the rotating group.

2. The hydraulic unit according to claim 1, wherein the hydraulic unit comprise more than one servo unit with working directions substantially parallel to each other.

3. The hydraulic unit according to claim 1, comprising two servo units arranged symmetrically with regard to the swivel element tilt axis, such that the movement of one servo piston towards the rotating group causes the other servo piston to enter into the respective servo cylinder.

4. The hydraulic unit according to claim 3, comprising two pairs of servo units, with each pair having one servo unit on either side of the swivel element tilt axis.

5. The hydraulic unit according to one of the preceding claims, wherein a skirt of the servo piston head shows a convex or spherical shape.

6. The hydraulic unit according to claim 1, wherein the servo piston shaft is connected to the swivel element in an articulated manner.

7. The hydraulic unit according to claim 1, wherein the connection of the servo piston shaft to the swivel element is a kind of ball joint, hinge joint, pin joint or similar, comprising a calotte on the swivel element into which a convex end of the servo piston shaft can be inserted, such that linear forces in direction of the servo piston shaft can be transmitted to the swivel element and vice versa.

8. The hydraulic unit according to claim 1, wherein the servo cylinder is a bore in the housing or a cylinder fixed to the inner side of the housing.

9. The hydraulic unit according to claim 1, wherein, in a neutral position of the swivel element, the rotating group do not show a displacement volume and the servo piston(s) are at half way of their possible stroke in the servo cylinder.

10. The hydraulic unit according to claim 1 wherein a tilt movement is provided by means of a stop surface stationary at the housing.

11. The hydraulic unit according to claim 1, wherein the servo cylinder can be pressurized by a servo pressure provided by a pressure source internal or external to the hydraulic unit and controlled by a control unit.

12. The hydraulic unit according to claim 11, wherein the external pressure source is a bolt-on pressure source having hydraulic fluid or air as working fluid.

13. The hydraulic unit according to claim 11, wherein the height of the servo pressure is provided in a load dependent manner.

14. The hydraulic unit according to claim 1, wherein a servo spring is located at the swivel element opposite to a servo unit and on the sliding surface side of the swivel element, in order to provide a restoring force to the swivel element when the swivel element is tilted away from an initial position by the allotted servo unit.

15. The hydraulic unit according to claim 1, wherein to each servo unit at least one servo spring is allotted.

16. The hydraulic unit according to claim 1, comprising restoring means for holding or restoring the swivel element into a neutral position, in which the stroke of the displacement pistons is zero, wherein the restoring means comprise at least two servo springs arranged with a first end on the sliding surface side of the swivel element, such that in neutral position of the swivel element the servo spring forces are balanced, and wherein the servo springs are attached with their second end to a fixing point stationary within the housing, preferably at the end cap of the hydraulic unit.

17. The hydraulic unit according to claim 16, wherein the servo springs are arranged symmetrically with respect to the tilt axis on the sliding surface side of the swivel element.

18. The hydraulic unit according to claim 16, wherein the restoring means provide for an end stop of a maximum tilt angle of the swivel element in either direction of tilt.

19. The hydraulic unit according to claim 14, wherein, in the initial position of the swivel element, the servo spring(s) is/are pre-tensioned.

20. The hydraulic unit according to claim 14, wherein the servo spring(s) is/are guided by internal or external guiding means and/or is/are attached with a first end in an articulated manner to the swivel element and with the second end to the fixing point, wherein the guiding means comprise at least at their first end a spring seat on which the servo spring can abut.
